(19) United States
(12) Patent Application Publication
(10) Pub. No.: US 2021/0210091 A1
(43) Pub. Date: Jul. 8, 2021

(54) METHOD, DEVICE, AND STORAGE MEDIUM FOR WAKING UP VIA SPEECH

(71) Applicant: BAIDU ONLINE NETWORK TECHNOLOGY (BEIJING) CO., LTD., Beijing (CN)

(72) Inventors: Xue MI, Beijing (CN); Rongsheng HUANG, Beijing (CN); Peng WANG, Beijing (CN); Yang MENG, Beijing (CN); You LUO, Beijing (CN); Xiaolong JIANG, Beijing (CN); Lu JIN, Beijing (CN); Xiwang JIANG, Beijing (CN); Xuan LI, Beijing (CN)

(73) Assignee: BAIDU ONLINE NETWORK TECHNOLOGY (BEIJING) CO., LTD.

(21) Appl. No.: 17/020,329

(22) Filed: Sep. 14, 2020

(30) Foreign Application Priority Data
Jan. 7, 2020 (CN) 202010015663.6

(51) Int. Cl. G10L 15/22; G10L 15/02

(52) U.S. Cl. CPC G10L 15/22; G10L 15/02

(57) ABSTRACT

The disclosure discloses a method, a device, and a storage medium for waking up via a speech. The method includes: collecting a wake-up speech of a user; generating wake-up information of a current intelligent device based on the wake-up speech and state information of the current intelligent device; sending the wake-up information of the current intelligent device to one or more non-current intelligent devices in a network; receiving wake-up information from the one or more non-current intelligent devices in the network; determining whether the current intelligent device is a target speech interaction device in combination with wake-up information of each intelligent device in the network; and controlling the current intelligent device to perform speech interaction with the user in a case that the current intelligent device is the target speech interaction device.

### CROSS-REFERENCE TO RELATED APPLICATION

This application claims priority to Chinese Patent Application No. 202010015663.6, filed on Jan. 7, 2020, the entire contents of which are incorporated herein by reference.

### FIELD

The disclosure relates to the field of speech processing technologies, particularly to the field of human-machine interaction technologies, and more particularly to a method, a device, and a storage medium for waking up via a speech.

### BACKGROUND

A plurality of intelligent speech devices, such as an intelligent speaker and an intelligent television, may be provided in networking of a scene such as a home. When a user speaks a wake-up speech including a wake-up word, the plurality of intelligent speech devices may respond at the same time. Therefore, there is a great interference to the wake-up speech, which reduces wake-up experience of the user, enables it difficult for the user to know about which device performs speech interaction with him/her, and causes poor speech interaction efficiency.

### SUMMARY

A first aspect of embodiments of the disclosure provides a method for waking up via a speech. The method includes: collecting a wake-up speech of a user; generating wake-up information of a current intelligent device based on the wake-up speech and state information of the current intelligent device; sending the wake-up information of the current intelligent device to one or more non-current intelligent devices in a network; receiving wake-up information from the one or more non-current intelligent devices in the network; determining whether the current intelligent device is a target speech interaction device in combination with wake-up information of each intelligent device in the network; and controlling the current intelligent device to perform speech interaction with the user in a case that the current intelligent device is the target speech interaction device.

A second aspect of embodiments of the disclosure provides an electronic device. The electronic device includes at least one processor and a memory. The memory is communicatively coupled to the at least one processor. The memory is configured to store instructions executed by the at least one processor. When the instructions are executed by the at least one processor, the at least one processor is caused to implement the method for waking up via the speech according to the above embodiments of the disclosure.

A third aspect of embodiments of the disclosure provides a non-transitory computer readable storage medium having computer instructions stored thereon. When the computer instructions are executed, a computer is caused to execute the method for waking up via the speech according to the above embodiments of the disclosure.

### BRIEF DESCRIPTION OF THE DRAWINGS

The accompanying drawings are used for better understanding the solution, and do not constitute a limitation of the disclosure.

FIG. 1 is a schematic diagram according to a first embodiment of the disclosure.

FIG. 2 is a schematic diagram according to a second embodiment of the disclosure.

FIG. 3 is a schematic diagram illustrating a network according to an embodiment of the disclosure.

FIG. 4 is a schematic diagram according to a third embodiment of the disclosure.

FIG. 5 is a schematic diagram according to a fourth embodiment of the disclosure.

FIG. 6 is a schematic diagram according to a fifth embodiment of the disclosure.

FIG. 7 is a schematic diagram according to a sixth embodiment of the disclosure.

FIG. 8 is a schematic diagram according to a seventh embodiment of the disclosure.

FIG. 9 is a block diagram illustrating an electronic device capable of implementing a method for waking up via a speech according to embodiments of the disclosure.

### DETAILED DESCRIPTION

Description will be made below to exemplary embodiments of the disclosure with reference to accompanying drawings, including various details of embodiments of the disclosure to facilitate understanding, which should be regarded as merely exemplary. Therefore, it should be recognized by the skilled in the art that various changes and modifications may be made to the embodiments described herein without departing from the scope and spirit of the disclosure. Meanwhile, for clarity and conciseness, descriptions for well-known functions and structures are omitted in the following description.

Description will be made below to a method and an apparatus for waking up via a speech according to embodiments of the disclosure with reference to accompanying drawings.

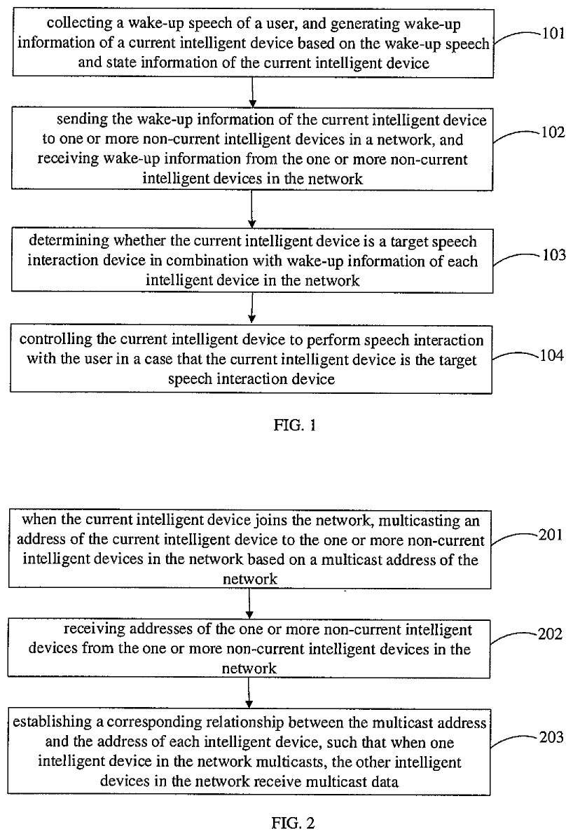

FIG. 1 is a schematic diagram according to a first embodiment of the disclosure.

As illustrated in FIG. 1, the method for waking up via the speech includes the following.

At block 101, a wake-up speech of a user is collected, and wake-up information of a current intelligent device is generated based on the wake-up speech and state information of the current intelligent device.

In some embodiments of the disclosure, the current intelligent device may be any intelligent device in a network, that is, any intelligent device in the network may execute the method illustrated in FIG. 1. In some embodiments of the disclosure, the current intelligent device may collect a speech of the user in real time and recognize the speech. When a preset wake-up word is recognized from the speech of the user, it is determined that the wake-up speech of the user is collected. For example, the wake-up word may be “Xiaodu, Xiaodu”, “Ruoqi”, “Dingdong Dingdong” and on the like.

Alternatively, the wake-up information of the current intelligent device is generated based on the wake-up speech and the state information of the current intelligent device. As an example, the wake-up information of the current intelligent device may be generated based on an intensity of the wake-up speech, whether the current intelligent device is in an active state, whether the current intelligent device is gazed by human eyes, and whether the current intelligent device is pointed by a gesture. Whether the current intelligent device is in the active state may be, such as, whether the current intelligent device is playing video and music, etc. In addition, it should be noted that the wake-up information may include, but be not limited to, the intensity of the wake-up speech, and any one or more of: whether the intelligent device is in the active state, whether the intelligent device is gazed by the human eyes, and whether the intelligent device is pointed by the gesture. It should be noted that the intelligent device may be disposed with a camera for collecting a face image or a human eye image, thereby determining whether the intelligent device is gazed by the human eyes and pointed by the gesture.

In order to enable the current intelligent device to send the corresponding wake-up information to other intelligent devices and to receive wake-up information from other intelligent devices, alternatively, as illustrated in FIG. 2, FIG. 2 is a schematic diagram according to a second embodiment of the disclosure. Before the wake-up speech of the user is collected by the current intelligent device, and the wake-up information of the current intelligent device is generated based on the wake-up speech and the state information of the current intelligent device, a corresponding relationship between an address of each intelligent device and a multicast address of the network may be established, which may include the following.

At block 201, when the current intelligent device joins the network, an address of the current intelligent device is multicasted to the one or more non-current intelligent devices in the network based on a multicast address of the network.

It may be understood that networking among the intelligent devices may be performed in a wireless mean that may include, but be not limited to, WIFI (Wireless Fidelity), Bluetooth, ZigBee, etc.

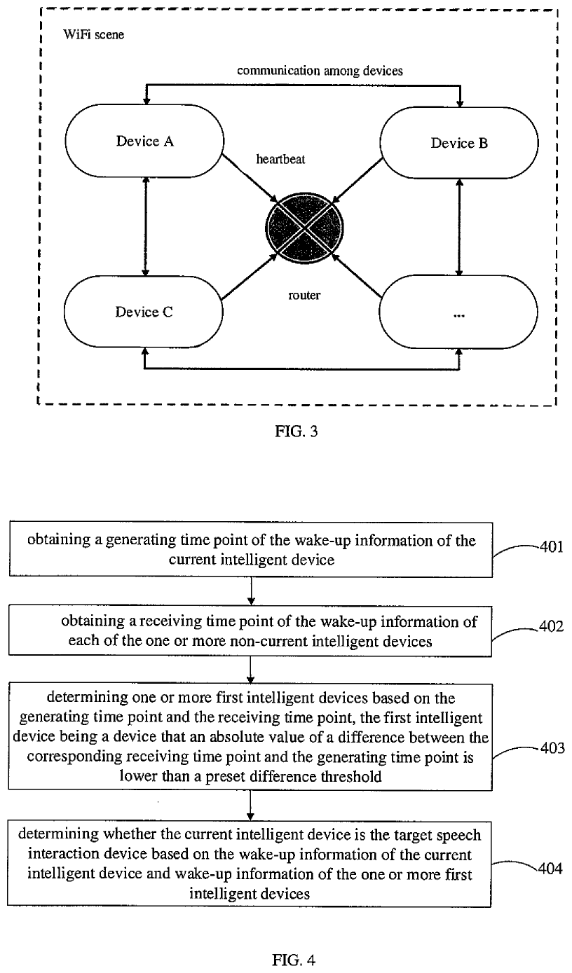

As an example, when the intelligent devices are networked through WIFI, by setting a router and setting an address of the router as the multicast address, the intelligent devices may send data to the router and forward the data to other intelligent devices through the router. As illustrated in FIG. 3, data is forwarded through the router among intelligent devices A, B, and C, and a dynamic update of a device list may be maintained among the intelligent devices by utilizing a heartbeat.

As another example, when the intelligent devices are networked through Bluetooth, each intelligent device may be used as the router for data forwarding among the intelligent devices. For example, when data is forwarded between the intelligent device A and the intelligent device C, the intelligent device B located between the intelligent device A and the intelligent device C may be used as the router, thereby implementing data forwarding between the intelligent device A and the intelligent device C.

As another example, when the intelligent devices are networked through ZigBee, taking some intelligent devices with a routing function as an example, the intelligent devices with the routing function may directly forward data, while intelligent devices without the routing function may report data to the intelligent devices with the routing function, thereby completing data forwarding among the intelligent devices.

In some embodiments of the disclosure, when the current intelligent device joins the network, the router in the network may record the address of the current intelligent device, record the corresponding relationship between the multicast address and the address of the current intelligent device, and send the address of the current intelligent device to other intelligent devices having the corresponding relationship with the multicast address. It should be noted that each intelligent device in the network may have a same multicast address and a unique device address.

At block 202, addresses of the one or more non-current intelligent devices from the one or more non-current intelligent devices in the network are received.

At block 203, a corresponding relationship between the multicast address and the address of each intelligent device is established, such that when one intelligent device in the network multicasts, the other intelligent devices in the network receive multicast data.

In some embodiments of the disclosure, when each intelligent device joins the network, the router records the address of each intelligent device and the corresponding relationship between the multicast address and the address of each intelligent device, such that the corresponding relationship between the multicast address and the address of each intelligent device may be established. In this way, each intelligent device may have a list including addresses of all intelligent devices in the network, and the other intelligent devices in the network may receive the multicast data when one intelligent device in the network multicasts.

It should be noted that, after the corresponding relationship between the multicast address and the address of each intelligent device is established, when the current intelligent device receives data with a destination address of the multicast address, the current intelligent device may determine that the data is sent to itself.

At block 102, the wake-up information of the current intelligent device is sent to one or more non-current intelligent devices in a network, and wake-up information from the one or more non-current intelligent devices in the network is received.

In some embodiments of the disclosure, the wake-up information carrying a marker of the current intelligent device may be sent to the other intelligent devices in the network through the router in the network, and the wake-up information from the other intelligent devices in the network may be received by the current intelligent device.

At block 103, it is determined whether the current intelligent device is a target speech interaction device in combination with wake-up information of each intelligent device in the network.

As an example, one or more first intelligent devices are determined based on generating time points and receiving time points of the wake-up information of the intelligent devices, and it is determined whether the current intelligent device is the target speech interaction device based on the wake-up information of the current intelligent device and the wake-up information of the one or more first intelligent devices. As another example, respective parameters in the wake-up information of respective intelligent devices in the network are calculated based on a preset calculation strategy, and calculation results of respective parameters of respective intelligent devices are compared, to determine whether the current intelligent device is the target speech interaction device. As another example, each parameter in the wake-up information of the current intelligent device is calculated, each parameter in the wake-up information of each of the one or more first intelligent devices is calculated, and a calculation result of each parameter in the wake-up information of the current intelligent device is compared with a calculation result of each parameter of each of the one or more first intelligent devices, to determine whether the current intelligent device is the target speech interaction device. See the description of subsequent embodiments for details.

At block 104, the current intelligent device is controlled to perform speech interaction with the user in a case that the current intelligent device is the target speech interaction device.

In some embodiments of the disclosure, when the current intelligent device is the target speech interaction device, the current intelligent device responds to the wake-up word of the user, and then performs speech interaction with the user.

With the method for waking up via the speech according to the embodiments of the disclosure, the wake-up speech of the user is collected, and the wake-up information of the current intelligent device is generated based on the wake-up speech and the state information of the current intelligent device. The wake-up information of the current intelligent device is sent to the one or more non-current intelligent devices in the network, and the wake-up information from the one or more non-current intelligent devices in the network is received. It is determined whether the current intelligent device is the target speech interaction device in combination with the wake-up information of each intelligent device in the network. The current intelligent device is controlled to perform speech interaction with the user in the case that the current intelligent device is the target speech interaction device. According to the method, an optimal intelligent device is determined in combination with the wake-up information of each intelligent device, and the optimal intelligent device responds to the wake-up word of the user, thereby avoiding interference caused when a plurality of intelligent devices respond to the user at the same time, such that the user may clearly know about which intelligent device is the one for speech interaction, and the intelligent interaction efficiency is high.

FIG. 4 is a schematic diagram according to a third embodiment of the disclosure. As illustrated as FIG. 4, the one or more first intelligent devices are determined based on the generating time point and the receiving time point of the wake-up information of the intelligent devices, and it is determined whether the current intelligent device is the target speech interaction device based on the wake-up information of the current intelligent device and the wake-up information of the one or more first intelligent devices. A detailed implementing procedure is as follows.

At block 401, a generating time point of the wake-up information of the current intelligent device is obtained.

It may be understood that, when the current intelligent device generates the wake-up information of the current intelligent device based on the wake-up speech and the state information of the current intelligent device, the generating time point of the wake-up information may be recorded, thereby obtaining the generating time point at which the wake-up information of the current intelligent device is generated.

At block 402, a receiving time point of the wake-up information of each of the one or more non-current intelligent devices is obtained.

In some embodiments of the disclosure, the current intelligent device may record the receiving time point when receiving the wake-up information from each of the one or more non-current intelligent devices in the network, thereby obtaining the receiving time point at which the wake-up information of each of the one or more non-current intelligent devices is received.

At block 403, one or more first intelligent devices are determined based on the generating time point and the receiving time point. The first intelligent device is a device that an absolute value of a difference between the corresponding receiving time point and the generating time point is lower than a preset difference threshold.

For example, the generating time point is taken as t, and the preset difference threshold is taken as m as an example. When the current intelligent device receives the wake-up information of the non-current intelligent device within a time range (t−m, t+m), the non-current intelligent device is taken as the first intelligent device.

At block 404, it is determined whether the current intelligent device is the target speech interaction device based on the wake-up information of the current intelligent device and wake-up information of the one or more first intelligent devices.

In some embodiments of the disclosure, each wake-up information may be compared based on the wake-up information of the current intelligent device and the wake-up information of the one or more first intelligent devices. An optimal speech interaction device may be determined based on a comparison strategy, and then the optimal speech interaction device is taken as the target speech interaction device. As an example, an intensity of a speech signal in the wake-up information of the current smart device may be compared with an intensity of a speech signal in each of the one or more first intelligent devices. For example, the closer an intelligent device is to the user, the larger the speech signal, and the intelligent device may be regarded as the target speech interaction device for priority response. As another example, it may be determined whether the current intelligent device and the one or more first intelligent devices are in the active state. When an intelligent device is in the active state, for example, the intelligent device is playing video, playing music, etc., the intelligent device may be taken as the target speech interaction device for priority response. As another example, it may be determined whether the current intelligent device and the first intelligent device are gazed by the human eyes or pointed by the gesture. When an intelligent device is gazed by the human eyes or pointed by the gesture, in combination with the wake-up speech in the wake-up information, the intelligent device gazed by the human eyes or pointed by the gesture may be regarded as the target speech interaction device for priority response. As another example, a priority is set for each parameter in the wake-up information. For example, the intelligent device gazed by the human eyes or pointed by the gesture has the highest priority, and the intelligent device in the active state has the second highest priority. The intelligent devices gazed by the human eyes may be preferentially obtained, and the intelligent devices in the active state may be selected from the intelligent devices gazed by the human eyes or pointed by the gesture, and then the intelligent device with the highest intensity of the wake-up speech may be selected from the intelligent devices in the active state as the target speech interaction device for priority response.

It should be noted that, when a decision is made based on the comparison strategy, the intelligent device may obtain the obtaining time point of the wake-up information of the intelligent device, obtain the wake-up information received within a time range centered on the obtaining time point, and make a decision based on the wake-up information received within the time range and the wake-up information of the intelligent device. The intelligent device may be taken as the optimal intelligent device when not receiving the wake-up information of other intelligent devices within the time range.

In conclusion, by comparing the wake-up information of respective intelligent devices, the optimal interaction device is determined based on the comparison strategy. The optimal interaction device responds to the wake-up word of the user, and then performs speech interaction with the user, thereby avoiding the interference caused when the plurality of intelligent devices respond to the user at the same time, such that the user may clearly know about which intelligent device is the one for speech interaction with the user, and the speech interaction efficiency is high.

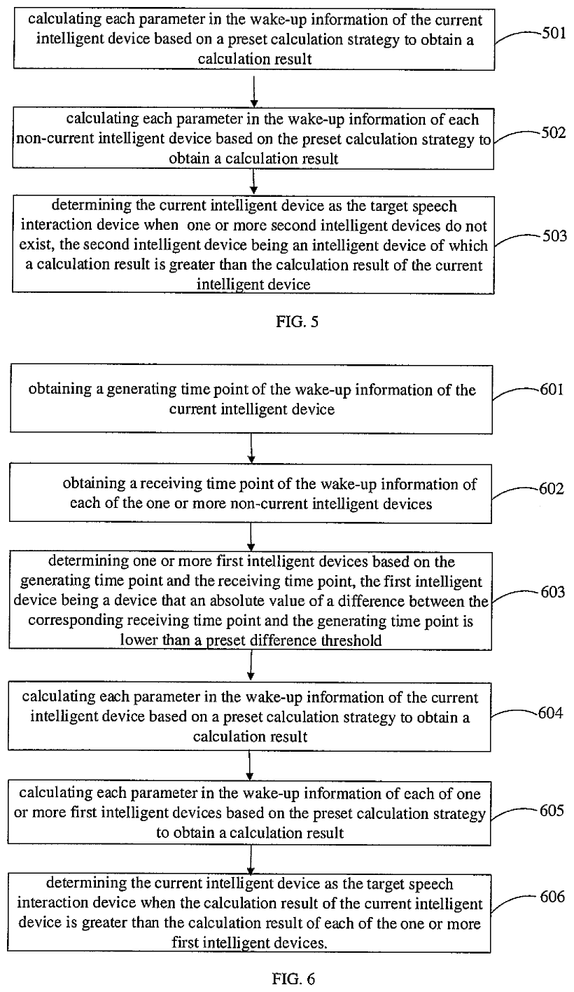

FIG. 5 is a schematic diagram according to a fourth embodiment of the disclosure. As illustrated in FIG. 5, each parameter in the wake-up information of each intelligent device in the network is calculated, and the calculation results of respective parameters of respective intelligent devices are compared, thereby determining whether the current intelligent device is the target speech interaction device. The detailed implementation procedure is as follows.

At block 501, each parameter in the wake-up information of the current intelligent device is calculated based on a preset calculation strategy, to obtain a calculation result.

At block 502, each parameter in the wake-up information of each non-current intelligent device is calculated based on the preset calculation strategy, to obtain a calculation result.

At block 503, the current intelligent device is determined as the target speech interaction device when one or more second intelligent devices do not exist. The second intelligent device is an intelligent device of which a calculation result is greater than the calculation result of the current intelligent device.

In some embodiments of the disclosure, each parameter in the wake-up information of the current intelligent device and each parameter in the wake-up information of the non-current intelligent device are calculated based on the preset calculation strategy, to obtain the calculation result of the wake-up information of the current intelligent device and the calculation result of the wake-up information of the non-current intelligent device. The calculation result of the wake-up information of the current intelligent device is compared with the calculation result of the non-current intelligent device. When the calculation result of the non-current intelligent device is greater than the calculation result of the current intelligent device, the non-current intelligent device is taken as the second intelligent device. When there is no second intelligent device, the current intelligent device may be taken as the optimal interaction device. The optimal interaction device responds to the wake-up word of the user, and then performs speech interaction with the user. When there is the one or more second intelligent devices, the wake-up information of the current intelligent device may be compared with the wake-up information of each of the one or more second intelligent devices based on actions at block 404 of the embodiment illustrated in FIG. 4, and the optimal interaction device may be determined based on the comparison strategy. Alternatively, the second intelligent device may be directly used as the optimal interaction device. It should be noted that the preset calculation strategy may include, but be not limited to, a weighted evaluation strategy.

In conclusion, each parameter in the wake-up information of each intelligent device in the network is calculated through the preset calculation strategy, and the calculation results of respective parameters of respective intelligent devices are compared, thereby determining the optimal intelligent device. The optimal intelligent device responds to the wake-up word of the user, thereby avoiding the interference caused when the plurality of intelligent devices respond to the user at the same time, such that the user may clearly know about which intelligent device is the one for speech interaction with the user, and the speech interaction efficiency is high.

FIG. 6 is a schematic diagram according to a fifth embodiment of the disclosure. As illustrated in FIG. 6, the first intelligent device is determined based on the generating time point and the receiving time point of the wake-up information of the intelligent devices. Respective parameters in the wake-up information of the current intelligent device and the one or more first intelligent devices are calculated based on the preset calculation strategy. The calculation result of each parameter of the wake-up information of the current intelligent device is compared with the calculation result of each parameter of each of the one or more first intelligent devices, thereby determining whether the current intelligent device is the target speech interaction device. The detailed implementing procedure is as follows.

At block 601, a generating time point of the wake-up information of the current intelligent device is obtained.

At block 602, a receiving time point of the wake-up information of each of the one or more non-current intelligent devices is obtained.

At block 603, one or more first intelligent devices are determined based on the generating time point and the receiving time point. The first intelligent device is a device that an absolute value of a difference between the corresponding receiving time point and the generating time point is lower than a preset difference threshold.

At block 604, each parameter in the wake-up information of the current intelligent device is calculated based on a preset calculation strategy, to obtain a calculation result.

At block 605, each parameter in the wake-up information of each of the one or more first intelligent devices is calculated based on the preset calculation strategy, to obtain a calculation result.

At block 606, the current intelligent device is determined as the target speech interaction device when the calculation result of the current intelligent device is greater than the calculation result of each of the one or more first intelligent devices.

In some embodiments of the disclosure, the first intelligent device is determined based on the generating time point and the receiving time point of the wake-up information of the intelligent devices. Each parameter in the wake-up information of the current intelligent device and each parameter in the wake-up information of the one or more first intelligent devices are calculated based on the preset calculation strategy. The calculation result of each parameter of the wake-up information of the current intelligent device is compared with the calculation result of each parameter of each of the one or more first intelligent devices. The current intelligent device is determined as the target speech interaction device when the calculation result of the current intelligent device is greater than the calculation result of each of all the first intelligent devices. The first intelligent device is determined as the target speech interaction device when the calculation result of the first intelligent device is greater than the calculation result of the current intelligent device. When the calculation result of the current intelligent device is equal to the calculation result of each of the one or more first intelligent devices, the wake-up information of the current intelligent device may be compared with the wake-up information of each of the one or more first intelligent devices based on actions at block 404 of embodiments illustrated in FIG. 4, and the optimal interactive device may be determined based on the comparison strategy.

In conclusion, by comparing the calculation result of the current intelligent device with the calculation result of each of the one or more first intelligent devices, the optimal intelligent device is determined, and the optimal intelligent device responds to the wake-up word of the user, thereby avoiding the interference caused when the plurality of intelligent devices respond to the user at the same time, such that the user may clearly know about which intelligent device is the one for speech interaction with the user, and the speech interaction efficiency is high.

With the method for waking up via the speech according to embodiments of the disclosure, the wake-up speech of the user is collected, and the wake-up information of the current intelligent device is generated based on the wake-up speech and the state information of the current intelligent device. The wake-up information of the current intelligent device is sent to the one or more non-current intelligent devices in the network, and the wake-up information from the one or more non-current intelligent devices in the network is received. It is determined whether the current intelligent device is the target speech interaction device in combination with the wake-up information of each intelligent device in the network. The current intelligent device is controlled to perform speech interaction with the user in the case that the current intelligent device is the target speech interaction device. According to the method, the optimal intelligent device is determined in combination with the wake-up information of each intelligent device, and the optimal intelligent device responds to the wake-up word of the user, thereby avoiding interference caused when the plurality of intelligent devices responding to the user at the same time, such that the user mat clearly know about which intelligent device is the one for speech interaction with the user, and the intelligent interaction efficiency is high.

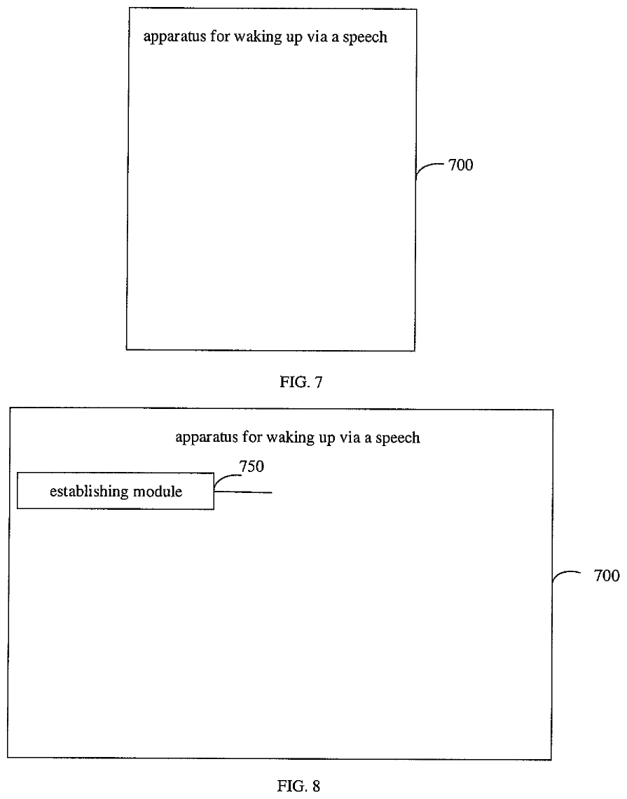

Corresponding to the method for waking up via the speech according to the above embodiments, an embodiment of the disclosure also provides an apparatus for waking up via a speech. Since the apparatus for waking up via the speech according to this embodiment corresponds to the method for waking up via the speech according to the above embodiments, the embodiments of the method for waking up via the speech are also applicable to the apparatus for waking up via the speech according to this embodiment, which may not be described in detail in this embodiment. FIG. 7 is a block diagram according to a sixth embodiment of the disclosure. As illustrated in FIG. 7, the apparatus 700 for waking up via the speech includes: a collecting model 710, a sending-receiving module 720, a determining module 730, and a controlling module 740.

The collecting model 710 is configured to collect a wake-up speech of a user, and to generate wake-up information of a current intelligent device based on the wake-up speech and state information of the current intelligent device. The sending-receiving module 720 is configured to send the wake-up information of the current intelligent device to one or more non-current intelligent devices in a network, and to receive wake-up information from the one or more non-current intelligent devices in the network. The determining module 730 is configured to determine whether the current intelligent device is a target speech interaction device in combination with wake-up information of each intelligent device in the network. The controlling module 740 is configured to control the current intelligent device to perform speech interaction with the user in a case that the current intelligent device is the target speech interaction device.

As an impossible implementation of embodiments of the disclosure, the determining module 730 is configured to: obtain a generating time point of the wake-up information of the current intelligent device; obtain a receiving time point of the wake-up information of the one or more non-current intelligent devices; determine one or more first intelligent devices based on the generating time point and the receiving time point, the first intelligent device being a device that an absolute value of a difference between the receiving time point and the generating time point is lower than a preset difference threshold; and determine whether the current intelligent device is the target speech interaction device based on the wake-up information of the current intelligent device and wake-up information of the one or more first intelligent devices.

As an impossible implementation of embodiments of the disclosure, as illustrated in FIG. 8, on the basis of FIG. 7, the apparatus for waking up via the speech also includes an establishing module 750.

The sending-receiving module 720 is further configured to, when the current intelligent device joins the network, multicast an address of the current intelligent device to the one or more non-current intelligent devices in the network based on a multicast address of the network; and receive addresses of the one or more non-current intelligent devices returned by the one or more non-current intelligent devices in the network. The establishing module 750 is configured to establish a corresponding relationship between the multicast address and the address of each intelligent device, such that when one intelligent device in the network multicasts, the other intelligent devices in the network receive multicast data.

As an impossible implementation of embodiments of the disclosure, the determining module 730 is configured to: calculate each parameter in the wake-up information of the current intelligent device based on a preset calculation strategy to obtain a calculation result; calculate each parameter in the wake-up information of each non-current intelligent device based on the preset calculation strategy to obtain a calculation result; and determine the current intelligent device as the target speech interaction device when one or more second intelligent devices do not exist, the second intelligent device being an intelligent device of which a calculation result is greater than the first calculation result of the current intelligent device.

As an impossible implementation of embodiments of the disclosure, the wake-up information includes a wake-up speech intensity and any one or more of: whether the intelligent device is in an active state, whether the intelligent device is gazed by human eyes, and whether the intelligent device is pointed by a gesture.

With the apparatus for waking up via the speech according to this embodiment of the disclosure, the wake-up speech of the user is collected, and the wake-up information of the current intelligent device is generated based on the wake-up speech and the state information of the current intelligent device. The wake-up information of the current intelligent device is sent to the one or more non-current intelligent devices in the network, and the wake-up information from the one or more non-current intelligent devices in the network is received. It is determined whether the current intelligent device is the target speech interaction device in combination with the wake-up information of each intelligent device in the network. The current intelligent device is controlled to perform speech interaction with the user in the case that the current intelligent device is the target speech interaction device. According to the apparatus, the optimal intelligent device is determined in combination with the wake-up information of each intelligent device, and the optimal intelligent device responds to the wake-up word of the user, thereby avoiding interference caused by a plurality of intelligent devices responding to the user at the same time, such that the user may clearly determine which intelligent device is the one for speech interaction with the user, and the intelligent interaction efficiency is high.

According to embodiments of the disclosure, the disclosure also provides an electronic device and a readable storage medium.

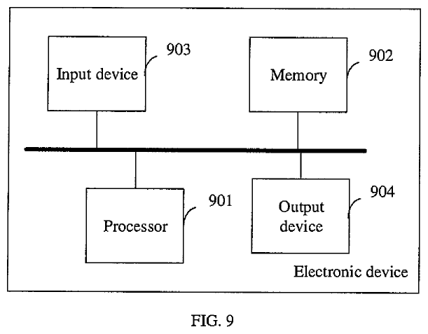

As illustrated in FIG. 9, FIG. 9 is a block diagram an electronic device capable of implementing a method for waking up via a speech according to embodiments of the disclosure. The electronic device aims to represent various forms of digital computers, such as a laptop computer, a desktop computer, a workstation, a personal digital assistant, a server, a blade server, a mainframe computer and other suitable computer. The electronic device may also represent various forms of mobile devices, such as personal digital processing, a cellular phone, a smart phone, a wearable device and other similar computing device. The components illustrated herein, connections and relationships of the components, and functions of the components are merely examples, and are not intended to limit the implementation of the disclosure described and/or claimed herein.

As illustrated in FIG. 9, the electronic device includes: one or more processors 901, a memory 902, and interfaces for connecting various components, including a high-speed interface and a low-speed interface. Various components are connected to each other by different buses, and may be mounted on a common main board or in other ways as required. The processor may process instructions executed within the electronic device, including instructions stored in or on the memory to display graphical information of the GUI (graphical user interface) on an external input/output device (such as a display device coupled to an interface). In other implementations, a plurality of processors and/or a plurality of buses may be used together with a plurality of memories if desired. Similarly, a plurality of electronic devices may be connected, and each electronic device provides some necessary operations (for example, as a server array, a group of blade servers, or a multiprocessor system). In FIG. 9, a processor 901 is taken as an example.

The memory 902 is a non-transitory computer readable storage medium provided by the disclosure. The memory is configured to store instructions executed by at least one processor, to enable the at least one processor to execute a method for waking up via a speech provided by the disclosure. The non-transitory computer readable storage medium provided by the disclosure is configured to store computer instructions. The computer instructions are configured to enable a computer to execute the method for waking up via the speech provided by the disclosure.

As the non-transitory computer readable storage medium, the memory 902 may be configured to store non-transitory software programs, non-transitory computer executable programs and modules, such as program instructions/modules (such as, the collecting model 710, the sending-receiving module 720, the determining module 730, and the controlling module 740 and the establishing module 750 illustrated in FIG. 7) corresponding to the method for waking up via the speech according to embodiments of the disclosure. The processor 901 is configured to execute various functional applications and data processing of the server by operating non-transitory software programs, instructions and modules stored in the memory 4902, that is, to implement the method for waking up via the speech according to the above method embodiment.

The memory 902 may include a storage program region and a storage data region. The storage program region may store an application required by an operating system and at least one function. The storage data region may store data created according to the use of the electronic device capable of implementing the method for waking up via the speech. In addition, the memory 902 may include a high-speed random-access memory, and may also include a non-transitory memory, such as at least one disk memory device, a flash memory device, or other non-transitory solid-state memory device. In some embodiments, the memory 902 may optionally include memories located remotely with respect to the processor 901, and these remote memories may be connected to the electronic device capable of implementing the method for waking up via the speech through a network. Examples of the above network include, but are not limited to, an Internet, an intranet, a local area network, a mobile communication network and combinations thereof.

The electronic device capable of implementing the method for waking up via the speech may also include: an input device 903 and an output device 904. The processor 901, the memory 902, the input device 903, and the output device 904 may be connected through a bus or in other means. In FIG. 9, the bus is taken as an example.

The input device 903 may receive inputted digital or character information, and generate key signal input related to user setting and function control of the electronic device capable of implementing the method for waking up via the speech, such as a touch screen, a keypad, a mouse, a track pad, a touch pad, an indicator stick, one or more mouse buttons, a trackball, a joystick and other input device. The output device 904 may include a display device, an auxiliary lighting device (e.g., LED), a haptic feedback device (e.g., a vibration motor), and the like. The display device may include, but be not limited to, a liquid crystal display (LCD), a light emitting diode (LED) display, and a plasma display. In some embodiments, the display device may be the touch screen.

The various implementations of the system and technologies described herein may be implemented in a digital electronic circuit system, an integrated circuit system, an application specific ASIC (application specific integrated circuit), a computer hardware, a firmware, a software, and/or combinations thereof. These various implementations may include: being implemented in one or more computer programs. The one or more computer programs may be executed and/or interpreted on a programmable system including at least one programmable processor. The programmable processor may be a special purpose or general-purpose programmable processor, may receive data and instructions from a storage system, at least one input device, and at least one output device, and may transmit the data and the instructions to the storage system, the at least one input device, and the at least one output device.

These computing programs (also called programs, software, software applications, or codes) include machine instructions of programmable processors, and may be implemented by utilizing high-level procedures and/or object-oriented programming languages, and/or assembly/machine languages. As used herein, the terms “machine readable medium” and “computer readable medium” refer to any computer program product, device, and/or apparatus (such as, a magnetic disk, an optical disk, a memory, a programmable logic device (PLD)) for providing machine instructions and/or data to a programmable processor, including machine readable medium that receives machine instructions as a machine readable signal. The term “machine readable signal” refers to any signal for providing the machine instructions and/or data to the programmable processor.

To provide interaction with a user, the system and technologies described herein may be implemented on a computer. The computer has a display device (such as, a CRT (cathode ray tube) or a LCD (liquid crystal display) monitor) for displaying information to the user, a keyboard and a pointing device (such as, a mouse or a trackball), through which the user may provide the input to the computer. Other types of devices may also be configured to provide interaction with the user. For example, the feedback provided to the user may be any form of sensory feedback (such as, visual feedback, auditory feedback, or tactile feedback), and the input from the user may be received in any form (including acoustic input, voice input or tactile input).

The system and technologies described herein may be implemented in a computing system including a background component (such as, a data server), a computing system including a middleware component (such as, an application server), or a computing system including a front-end component (such as, a user computer having a graphical user interface or a web browser through which the user may interact with embodiments of the system and technologies described herein), or a computing system including any combination of such background component, the middleware components, or the front-end component. Components of the system may be connected to each other through digital data communication in any form or medium (such as, a communication network). Examples of the communication network include a local area network (LAN), a wide area networks (WAN), and the Internet.

The computer system may include a client and a server. The client and the server are generally remote from each other and usually interact through the communication network. A relationship between client and server is generated by computer programs operated on a corresponding computer and having a client-server relationship with each other.

It should be understood that blocks illustrated above may be reordered, added or deleted using the various forms. For example, the blocks described in the disclosure may be executed in parallel, sequentially or in a different order, so long as a desired result of the technical solution disclosed in the disclosure may be achieved, there is no limitation here.

The above detailed embodiments do not limit the scope of the disclosure. It should be understood by the skilled in the art that various modifications, combinations, sub-combinations and substitutions may be made based on a design requirement and other factors. Any modification, equivalent substitution and improvement made within the spirit and principle of the disclosure shall be included in the protection scope of the disclosure.

What is claimed is:

1. A method for waking up via a speech, comprising:
collecting a wake-up speech of a user;
generating wake-up information of a current intelligent device based on the wake-up speech and state information of the current intelligent device;
sending the wake-up information of the current intelligent device to one or more non-current intelligent devices in a network;
receiving wake-up information from the one or more non-current intelligent devices in the network;
determining whether the current intelligent device is a target speech interaction device in combination with wake-up information of each intelligent device in the network; and
controlling the current intelligent device to perform speech interaction with the user in a case that the current intelligent device is the target speech interaction device.

2. The method of claim 1, wherein determining whether the current intelligent device is the target speech interaction device in combination with the wake-up information of each intelligent device in the network comprises:
obtaining a generating time point of the wake-up information of the current intelligent device;
obtaining a receiving time point of the wake-up information of each of the one or more non-current intelligent devices;
determining one or more first intelligent devices based on the generating time point and the receiving time point, the first intelligent device being a device that an absolute value of a difference between the corresponding receiving time point and the generating time point is lower than a preset difference threshold; and
determining whether the current intelligent device is the target speech interaction device based on the wake-up information of the current intelligent device and wake-up information of the one or more first intelligent devices.

3. The method of claim 1, further comprising:
when the current intelligent device joins the network, multicasting an address of the current intelligent device to the one or more non-current intelligent devices in the network based on a multicast address of the network;
receiving addresses of the one or more non-current intelligent devices from the one or more non-current intelligent devices in the network; and
establishing a corresponding relationship between the multicast address and the address of each intelligent device, such that when one intelligent device in the network multicasts, the other intelligent devices in the network receive multicast data.

4. The method of claim 1, wherein determining whether the current intelligent device is the target speech interaction device in combination with the wake-up information of each intelligent device in the network comprises:
calculating each parameter in the wake-up information of the current intelligent device based on a preset calculation strategy to obtain a calculation result;
calculating each parameter in the wake-up information of each non-current intelligent device based on the preset calculation strategy to obtain a calculation result; and
determining the current intelligent device as the target speech interaction device when one or more second intelligent devices do not exist, the second intelligent device being an intelligent device of which a calculation result is greater than the calculation result of the current intelligent device.

5. The method of claim 1, wherein the wake-up information comprises an intensity of the wake-up speech and any one or more of: whether the intelligent device is in an active state, whether the intelligent device is gazed by human eyes, and whether the intelligent device is pointed by a gesture.

6. The method of claim 1, wherein determining whether the current intelligent device is the target speech interaction device in combination with the wake-up information of each intelligent device in the network comprises:
obtaining a generating time point of the wake-up information of the current intelligent device;
obtaining a receiving time point of the wake-up information of each of the one or more non-current intelligent devices;
determining one or more first intelligent devices based on the generating time point and the receiving time point, the first intelligent device being a device that an absolute value of a difference between the corresponding receiving time point and the generating time point is lower than a preset difference threshold;
calculating each parameter in the wake-up information of the current intelligent device based on a preset calculation strategy to obtain a calculation result;
calculating each parameter in the wake-up information of each first intelligent device based on the preset calculation strategy to obtain a calculation result; and
determining the current intelligent device as the target speech interaction device when the calculation result of the current intelligent device is greater than the calculation result of each first intelligent device.

7. An electronic device, comprising:
at least one processor; and
a memory, communicatively coupled to the at least one processor,
wherein the memory is configured to store instructions executed by the at least one processor, and when the instructions are executed by the at least one processor, the at least one processor is caused to implement a method comprising:
collecting a wake-up speech of a user;
generating wake-up information of a current intelligent device based on the wake-up speech and state information of the current intelligent device;
sending the wake-up information of the current intelligent device to one or more non-current intelligent devices in a network;
receiving wake-up information from the one or more non-current intelligent devices in the network;
determining whether the current intelligent device is a target speech interaction device in combination with wake-up information of each intelligent device in the network; and
controlling the current intelligent device to perform speech interaction with the user in a case that the current intelligent device is the target speech interaction device.

8. The electronic device of claim 7, wherein determining whether the current intelligent device is the target speech interaction device in combination with the wake-up information of each intelligent device in the network comprises:
obtaining a generating time point of the wake-up information of the current intelligent device;
obtaining a receiving time point of the wake-up information of each of the one or more non-current intelligent devices;
determining one or more first intelligent devices based on the generating time point and the receiving time point, the first intelligent device being a device that an absolute value of a difference between the corresponding receiving time point and the generating time point is lower than a preset difference threshold; and
determining whether the current intelligent device is the target speech interaction device based on the wake-up information of the current intelligent device and wake-up information of the one or more first intelligent devices.

9. The electronic device of claim 7, the method further comprising:
when the current intelligent device joins the network, multicasting an address of the current intelligent device to the one or more non-current intelligent devices in the network based on a multicast address of the network;
receiving addresses of the one or more non-current intelligent devices from the one or more non-current intelligent devices in the network; and
establishing a corresponding relationship between the multicast address and the address of each intelligent device, such that when one intelligent device in the network multicasts, the other intelligent devices in the network receive multicast data.

10. The electronic device of claim 7, wherein determining whether the current intelligent device is the target speech interaction device in combination with the wake-up information of each intelligent device in the network comprises:
calculating each parameter in the wake-up information of the current intelligent device based on a preset calculation strategy to obtain a calculation result;
calculating each parameter in the wake-up information of each non-current intelligent device based on the preset calculation strategy to obtain a calculation result; and
determining the current intelligent device as the target speech interaction device when one or more second intelligent devices do not exist, the second intelligent device being an intelligent device of which a calculation result is greater than the calculation result of the current intelligent device.

11. The electronic device of claim 7, wherein the wake-up information comprises an intensity of the wake-up speech and any one or more of: whether the intelligent device is in an active state, whether the intelligent device is gazed by human eyes, and whether the intelligent device is pointed by a gesture.

12. The electronic device of claim 7, wherein determining whether the current intelligent device is the target speech interaction device in combination with the wake-up information of each intelligent device in the network comprises:
obtaining a generating time point of the wake-up information of the current intelligent device;
obtaining a receiving time point of the wake-up information of each of the one or more non-current intelligent devices;
determining one or more first intelligent devices based on the generating time point and the receiving time point, the first intelligent device being a device that an absolute value of a difference between the corresponding receiving time point and the generating time point is lower than a preset difference threshold;
calculating each parameter in the wake-up information of the current intelligent device based on a preset calculation strategy to obtain a calculation result;
calculating each parameter in the wake-up information of each first intelligent device based on the preset calculation strategy to obtain a calculation result; and
determining the current intelligent device as the target speech interaction device when the calculation result of the current intelligent device is greater than the calculation result of each first intelligent device.

13. A non-transitory computer readable storage medium having computer instructions stored thereon, wherein when the computer instructions are executed, a computer is caused to execute a method comprising:
collecting a wake-up speech of a user;
generating wake-up information of a current intelligent device based on the wake-up speech and state information of the current intelligent device;
sending the wake-up information of the current intelligent device to one or more non-current intelligent devices in a network;
receiving wake-up information from the one or more non-current intelligent devices in the network;
determining whether the current intelligent device is a target speech interaction device in combination with wake-up information of each intelligent device in the network; and
controlling the current intelligent device to perform speech interaction with the user in a case that the current intelligent device is the target speech interaction device.

14. The non-transitory computer readable storage medium of claim 13, wherein determining whether the current intelligent device is the target speech interaction device in combination with the wake-up information of each intelligent device in the network comprises:
obtaining a generating time point of the wake-up information of the current intelligent device;
obtaining a receiving time point of the wake-up information of each of the one or more non-current intelligent devices;
determining one or more first intelligent devices based on the generating time point and the receiving time point, the first intelligent device being a device that an absolute value of a difference between the corresponding receiving time point and the generating time point is lower than a preset difference threshold; and
determining whether the current intelligent device is the target speech interaction device based on the wake-up information of the current intelligent device and wake-up information of the one or more first intelligent devices.

15. The non-transitory computer readable storage medium of claim 13, the method further comprising:
when the current intelligent device joins the network, multicasting an address of the current intelligent device to the one or more non-current intelligent devices in the network based on a multicast address of the network;
receiving addresses of the one or more non-current intelligent devices from the one or more non-current intelligent devices in the network; and
establishing a corresponding relationship between the multicast address and the address of each intelligent device, such that when one intelligent device in the network multicasts, the other intelligent devices in the network receive multicast data.

16. The non-transitory computer readable storage medium of claim 13, wherein determining whether the current intelligent device is the target speech interaction device in combination with the wake-up information of each intelligent device in the network comprises:
calculating each parameter in the wake-up information of the current intelligent device based on a preset calculation strategy to obtain a calculation result;
calculating each parameter in the wake-up information of each non-current intelligent device based on the preset calculation strategy to obtain a calculation result; and
determining the current intelligent device as the target speech interaction device when one or more second intelligent devices do not exist, the second intelligent device being an intelligent device of which a calculation result is greater than the calculation result of the current intelligent device.

17. The non-transitory computer readable storage medium of claim 13, wherein the wake-up information comprises an intensity of the wake-up speech and any one or more of: whether the intelligent device is in an active state, whether the intelligent device is gazed by human eyes, and whether the intelligent device is pointed by a gesture.

18. The non-transitory computer readable storage medium of claim 13, wherein determining whether the current intelligent device is the target speech interaction device in combination with the wake-up information of each intelligent device in the network comprises:
obtaining a generating time point of the wake-up information of the current intelligent device;
obtaining a receiving time point of the wake-up information of each of the one or more non-current intelligent devices;
determining one or more first intelligent devices based on the generating time point and the receiving time point, the first intelligent device being a device that an absolute value of a difference between the corresponding receiving time point and the generating time point is lower than a preset difference threshold;
calculating each parameter in the wake-up information of the current intelligent device based on a preset calculation strategy to obtain a calculation result;
calculating each parameter in the wake-up information of each first intelligent device based on the preset calculation strategy to obtain a calculation result; and
determining the current intelligent device as the target speech interaction device when the calculation result of the current intelligent device is greater than the calculation result of each first intelligent device.
